(19) United States
(12) Patent Application Publication
(10) Pub. No.: US 2026/0163042 A1
(43) Pub. Date: Jun. 11, 2026

(54) Testing system of selective dual mode type for fuel cell stacks or vapor/carbon dioxide co-electrolysis stacks

(71) Applicants: YI-JING WU, Taoyuan City (TW); SZU-HAN WU, Taoyuan (TW); YUNG-NENG CHENG, Taoyuan (TW); LIANG-WEI HUANG, Taoyuan (TW); CHIEN-KUO LIU, Taoyuan (TW)

(72) Inventors: YI-JING WU, Taoyuan City (TW); SZU-HAN WU, Taoyuan (TW); YUNG-NENG CHENG, Taoyuan (TW); LIANG-WEI HUANG, Taoyuan (TW); CHIEN-KUO LIU, Taoyuan (TW)

(21) Appl. No.: 18/976,366

(22) Filed: Dec. 11, 2024

(51) Int. Cl. H01M 8/1233; H01M 8/04291; H01M 8/04537; H01M 8/04701; H01M 8/04746; H01M 8/12

(52) U.S. Cl. CPC H01M 8/1233; H01M 8/04291; H01M 8/04559; H01M 8/04589; H01M 8/04619; H01M 8/04649; H01M 8/04708; H01M 8/04753; H01M 2008/1293

(57) ABSTRACT

A testing system of selective dual mode type for fuel cell stacks or vapor/CO₂ co-electrolysis stacks includes at least one testing structure, a reactant gas supply device, a vapor supply device, a power supply device, a power load device and a control-analyzing device. The power supply device and the power load device are connected to electrodes of the testing structure, and also connected to the control-analyzing device. When the testing structure is served for a fuel cell stack testing, the reactant gas supply device provides reactant gas into the testing structure, and a current generated by the fuel cell enters the power load device. When the testing structure is served for an electrolysis stack testing, the vapor supply device provides electrolysis vapor into the testing structure, and the power supply device exposes voltage on the electrodes.

### BACKGROUND OF THE INVENTION

### Field of the Invention

The invention relates to a technical field of an integrated testing apparatus of fuel cell stacks and electrolysis stacks, and more particularly to a testing system of selective dual mode type for fuel cell stacks or vapor/carbon dioxide co-electrolysis stacks.

### Description of the Related Art

As a goal for international net zero emissions is intended to be accomplished in 2050, clean energy sources with less carbon dioxide emission are preferred nowadays, and generation of electrical power with less carbon dioxide emission has also become one of the main developments in the research for energy source technology. The solid oxide fuel cell (SOFC) is a device generating electrical power through reactant gases (hydrogen/carbon monoxide) and oxygen in the air, which meets the requirement of less carbon dioxide emission. The hydrogen and carbon monoxide used in the solid oxide fuel cell can be generated by co-electrolysis of water and carbon dioxide occurred in a solid oxide electrolysis cell (SOEC). Electrical energy for electrolysis can be green energy generated by solar voltaic cell or wind power. Therefore, a composite device integrating the solid oxide fuel cell and the solid oxide fuel cell can be a pure green energy source facilitating the accomplishment of less carbon dioxide emission.

Conventional performance tests for the solid oxide fuel cell and the solid oxide electrolysis cell are operated by different kinds of stacks. When the stacks of one kind are chosen for the performance test, the stacks of the other kind must be detached or removed from test stage before the chosen stacks are installed thereon. The exchange process of stacks may increase the failure possibility of the stacks. Moreover, as the installation of peripheral devices depends upon the scale of the stacks in the performance tests, the apparatus equipped with single transmitting wire for the performance tests can sustain limited current, and often has a higher temperature or even fails when a larger current for the electrolysis is provided.

### BRIEF SUMMARY OF THE INVENTION

An object of the invention is to provide a testing system of selective dual mode type for fuel cell stacks or vapor/carbon dioxide co-electrolysis stacks, which solves the problems caused by the exchange process of stacks in the performance tests for the solid oxide fuel cell and the solid oxide electrolysis cell, and has peripheral devices sustaining larger current and power to prevent the failure condition caused by the larger current in the prior art.

The invention provides a testing system of selective dual mode type for fuel cell stacks or vapor/carbon dioxide co-electrolysis stacks. The testing system in accordance with an exemplary embodiment of the invention includes at least one testing structure, a reactant gas supply device, a vapor supply device, a power supply device, a power load device and a control-analyzing device. The testing structure includes a first electrode, a second electrode, a first gas path adjacent to the first electrode, a second gas path adjacent to the second electrode, and an ion conducting layer disposed between the first gas path and the second gas path. The reactant gas supply device provides a plurality of reactant gases selectively entering the first gas path and the second gas path. The vapor supply device provides a vapor selectively entering the first gas path or the second gas path. The power supply device and the power load device are both connected to the first electrode and the second electrode. The control-analyzing device is electrically connected to the power supply device and the power load device. When the at least one testing structure is operated as a fuel cell stack, the reactant gases enter the first gas path and the second gas path, and a current is generated between the first electrode and the second electrode and flows through the power load device, whereby the control-analyzing device obtains a plurality of first electrical property data of the power load device. When the at least one testing structure is operated as a vapor/CO₂ co-electrolysis stack, the power supply device provides a potential difference between the first electrode and the second electrode, the vapor enters the first gas path, whereby a plurality of electrolysis gases are generated at the first electrode and the second electrode and discharged from the testing structure, and the control-analyzing device obtains a plurality of second electrical property data of the power load device.

In another exemplary embodiment, the testing system further includes a reactant gas preheating device connected to the reactant gas supply device and the testing structure, wherein the reactant gases enter the reactant gas pre-heating device from the reactant gas supply device and is heated therein to a predetermined temperature, the heated reactant gases enter the testing structure.

In another exemplary embodiment, the testing system further includes a furnace housing the test structure, wherein the furnace is operated at a high temperature, and the reactant gas preheating device is disposed outsides the furnace.

In yet another exemplary embodiment, the reactant gas pre-heating device is electrically connected to the control-analyzing device where a value of the predetermined temperature is set.

In another exemplary embodiment, the reactant gas supply device comprises a reactant gas storage tank and a reactant gas pump, and the reactant gases enter the reactant gas pre-heating device from the reactant gas storage tank or after the reactant gases are pressurized by the reactant gas pump.

In yet another exemplary embodiment, the testing system further includes a storage tank and a pump, wherein water is stored in the storage tank, the water enters the pump from the storage tank and is pressurized therein, and the pressurized water enters the vapor supply device.

In another exemplary embodiment, the vapor supply device is electrically connected to the control-analyzing device, whereby the control-analyzing device controls a heating power for the vapor supply device.

In yet another exemplary embodiment, the testing system further includes a switching valve connected to the reactant gas supply device, the vapor supply device and the testing structure, wherein the switching valve is operated to switch communication of the reactant gas supply device with the testing structure or the vapor supply device with the testing structure.

In another exemplary embodiment, the switching valve is connected to and controlled by the control-analyzing device.

In yet another exemplary embodiment, the reactant gas supply device and the vapor supply device are electrically connected to the control-analyzing device.

In another exemplary embodiment, the control-analyzing device controls a switch between the fuel cell mode and the electrolysis cell mode.

In yet another exemplary embodiment, the testing system further includes an gas collection device, wherein the gases discharged from the testing structure enter the gas collection device for storage.

In another exemplary embodiment, the reactant gases include hydrogen, carbon monoxide, carbon dioxide, oxygen and steam.

The testing system of selective dual mode type for fuel cell stacks or vapor/carbon dioxide co-electrolysis stacks utilizes a single test structure to selectively operate the performance tests for fuel cell stacks or electrolysis stacks without changing the stacks as the prior art does, whereby the failure condition of the stack is prevented. Moreover, the first electrical property data and the second electrical property data are obtained from the power supply device and the power load device disposed outsides the test structure, and the first electrode and the second electrode of the test structure are connected to the power supply device and the power load device through multiple transmitting wires, whereby the failure condition caused by overload of the single transmitting wire is avoided.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of an embodiment of the testing system of selective dual mode type for fuel cell stacks or vapor/carbon dioxide co-electrolysis stacks of the present invention;

FIG. 2 is a schematic view of an embodiment of the test structure of the testing system of selective dual mode type for fuel cell stacks or vapor/carbon dioxide co-electrolysis stacks of the present invention; and

FIG. 3 is a flow chart of performance tests for fuel cell stacks or electrolysis stacks utilizing the testing system of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

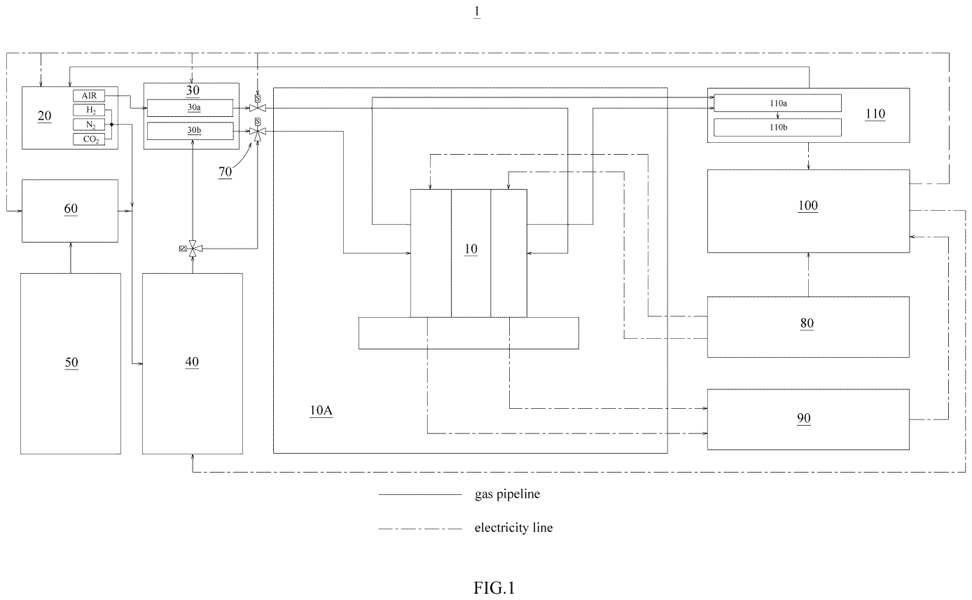

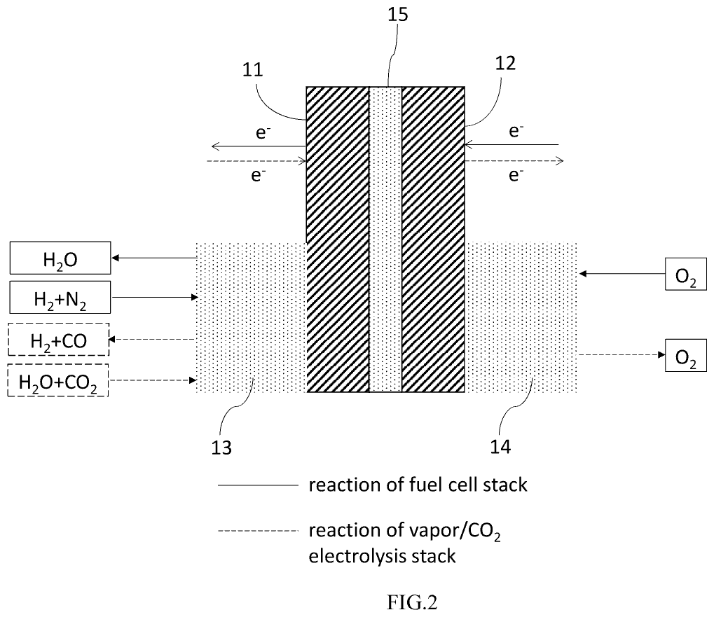

Referring to FIG. 1 and FIG. 2, an embodiment of the testing system of selective dual mode type for fuel cell stacks or vapor/carbon dioxide co-electrolysis stacks of the present invention is disclosed. The testing system 1 of the present embodiment includes a testing structure 10, a reactant gas supply device 20, a reactant gas pre-heating device 30, an vapor supply device 40, a storage tank 50, a pump 60, a switching valve 70, a power supply device 80, a power load device 90, a control-analyzing device 100 and a gas collection device 110.

As shown in FIG. 2, the testing structure 10 includes a first electrode 11, a second electrode 12, a first gas path 13, a second gas path 14 and an ion conducting layer 15. The first electrode 11 and the second electrode 12 are opposite arranged, and the ion conducting layer 15 is disposed between the first electrode 11 and the second electrode 12. The first gas path 13 is adjacent to the first electrode 11, and the second gas path 14 is adjacent to the second electrode 12. The testing structure 10 is adapt to operation of the solid oxide fuel cell (SOFC) and the solid oxide electrolysis cell (SOEC). The testing structure 10 is placed in a furnace 10A operated at a high temperature, whereas the reactant gas pre-heating device 30 is disposed outsides the furnace 10A. FIG. 2 illustrates a single testing structure 10 is used in the present embodiment, and in other embodiment, however, a plurality of the testing structures 10 are serially connected and stacked to form a testing stack. The ion conducting layer 15 is a solid oxide membrane composed of zirconium oxide dopped with yttrium oxide for drift of ions of oxygen (O²⁻⁾.

Referring to FIG. 1 again, the reactant gas supply device 20 provides several reactant gases including hydrogen (H₂), carbon dioxide (CO₂), nitrogen (N₂) and air (oxygen (O₂)). The reactant gas supply device 20 includes a reactant gas storage tank and a reactant gas pump. The reactant gases (such as hydrogen) can be pressurized for the storage in the reactant gas storage tank, and depressurized before they enter pipeline from the reactant gas storage tank. Alternatively, the reactant gases (such as oxygen and carbon dioxide) can be pressurized into pipeline through the reactant gas pump. For example, air (including oxygen) can be pumped into the pipeline through the reactant gas pump. When the testing structure 10 is operated as a fuel cell stack, the reactant gases provided from the reactant gas supply device 20 enter the first gas path 13 and the second gas path 14. For example, the hydrogen gas and carbon monoxide gas enter the first gas path 13, and the oxygen gas enters the second gas path 14. The oxidation reaction occurs at the first electrode 11 (anode) where the hydrogen molecules lose electrons to become hydrogen ions combined with oxygen ions to form water molecules. The reduction reaction occurs at the second electrode 12 (cathode) where the oxygen molecules receive the electrons to become oxygen ions drifting across the ion conducting layer 15 to reach the first electrode 11. Therefore, a current is generated between the first electrode 11 and the second electrode 12.

The reactant gas, the air, provided form the reactant gas supply device 20 directly enter the reactant gas preheating device 30 and is heated by an air preheating module 30a to a predetermined temperature. Other reactant gases, the hydrogen, the nitrogen and the carbon dioxide, enter the vapor supply device 40 and is mixed with the steam therein. The mixed gases enter the reactant gas preheating device 30 and are heated by a fuel preheating module 30b to a predetermined temperature. As the reactant temperature of the solid oxide fuel cell must be at least 700° C., the reactant gases are heated to 700° C. in the reactant gas preheating device 30 before they enter the testing structure 10. The reactant gas preheating device 30 generates heat to the preset temperature through electricity or high temperature gases discharged from boilers. Therefore, the testing system 1 of the present invention is adapted to various industry factories.

Water is stored in the storage tank 50. The pump 60 pumps the water from the storage tank into the vapor supply device 40 where water is evaporated to become vapor. The vapor supply device 40 generates heat through electricity or high temperature gases discharged from boilers. When the performance test of the electrolysis stack is operated, the vapor from the vapor supply device 40 enters the testing structure 10 for electrolysis reaction. When the performance test of the fuel cell stack is operated, the vapor provided by the vapor supply device 40 enters the reactant gas preheating device 30 where the vapor is mixed with the reactant gases and heated together to the preset temperature before they enter the testing structure 10.

When the testing structure 10 is operated as an electrolysis stack, the vapor enters the first gas path 13 or the second gas path 14 of the testing structure 10. A low voltage is imposed at the first electrode 11, and a high voltage is imposed at the second electrode 12. When the vapor enters the first gas path 13, the reduction action occurs at the first electrode 11 (cathode) where the vapor (steam and CO₂) receives electrons to generate oxygen ions, hydrogen molecules and CO molecules. The oxygen ions drift across the ion conducting layer 15 to reach the second electrode 12 (anode) where the oxygen ions experience the oxidation reaction and release electrons to form oxygen molecules. The hydrogen gas and the oxygen gas are discharged from the testing structure 10 and separately collected in the gas collection device 110. The hydrogen gas and the oxygen gas can be conducted into reactant gas storage tank 110a of the reactant gas supply device 20 from the gas collection device 110 for storage and used in the performance test of the fuel cell stack. The collected gases are transmitted to a gas analyzer 110b to analyze the ratios of collected gas. The generation rate of the vapor can be obtained through measurements of the change rate of pressure in the gas collection device 110 and the flow rate of the vapor.

The reactant gas supply device 20 and the vapor supply device 40 are connected to the testing structure 10 through the switching valve 70. When the performance test of the electrolysis stack is operated, the switching valve 70 enables the communication of the vapor supply device 40 and the testing structure 10 but disables the communication of the reactant gas supply device 20 and the testing structure 10. The vapor enters the testing structure 10 for electrolysis reaction. When the performance test of fuel cell stack is operated, the switching valve 70 enables the communication of the reactant gas supply device 20 and the testing structure 10 but disables the communication of the vapor supply device 40 and the testing structure 10. The reactant gases or the mixture of the reactant gases and the vapor enters the testing structure 10 for fuel cell reaction.

The power supply device 80 and the power load device 90 are connected to first electrode 11 and the second electrode 12. The first electrode 11 is connected to the power supply device 80 and the power load device 90 through multiple wires, and the second electrode 12 is also connected to the power supply device 80 and the power load device 90 through multiple wires, whereby a larger current is allowed to be imposed on the first electrode 11 and the second electrode 12 from the power supply device 80 when the performance test of electrolysis stack is operated, and a larger current, for example a current of a intensity up to 1 A/cm², is allowed to be generated at the first electrode 11 and the second electrode 12 and provided to the power load device 90 when the performance test of fuel cell stack is operated. As the currents are conducted through multiple wires, the current on each wire is limited to avoid damage.

The control-analyzing device 100 is electrically connected to the power supply device 80 and the power load device 90. When the performance test of fuel cell stack is operated, the current generated between the first electrode 11 and the second electrode 12 flow through the power load device 90. The control-analyzing device 100 obtains a plurality of first electrical property data, such as voltage value, current value and power value, and further obtain the impedance value of the fuel cell stack under the predetermined conditions. When the performance test of the electrolysis stack is operated, the power supply device provides a potential difference between the first electrode 11 and the second electrode 12. The control-analyzing device 100 obtains a plurality of second electrical property data, such as voltage value, current voltage and flow rate of the reactant gases, and further obtains the gas generation efficiency of the electrolysis stack under the predetermined conditions.

Moreover, the reactant gas preheating device 30 and the vapor supply device 40 are also electrically connected to the control-analyzing device 100, whereby the control-analyzing device 100 adjusts the temperature settings of the reactant gas preheating device 30 and also adjusts the heating power of the electrolysis vapor supply device 40. The switching valve 70 are also electrically connected to the control-analyzing device 100. The control-analyzing device 100 controls the switch of the switching valve 70 according to the operation of the testing structure 10 selected as the fuel cell stack or the electrolysis stack. Therefore, a user operates the control-analyzing device 100 for the switch of the performance tests between the fuel cell stacks and the vapor/carbon dioxide co-electrolysis stacks.

An example of switch from the performance test of the fuel cell stacks to the performance test of the vapor/carbon dioxide co-electrolysis stacks is described as follows. When the performance test of the fuel cell stacks is selected, the hydrogen gas at a flow rate of 0.8 LPM and the nitrogen gas at a flow rate of 0.2 LPM (liter per minute) are conducted into the first gas path 13, and the air at a flow rate of 2 LPM is conducted into the second gas path 14. Afterwards, when the process is switched to the performance test of the vapor/carbon dioxide co-electrolysis stacks, a steam generated by pure water at a flow rate of 0.64 ml/min is conducted into the first gas path 13, and at the same time according to output voltage variation measured at the power supply device 80, the hydrogen gas for the previous performance test of fuel cell stacks is gradually decreased to a flow rate of 0.22 LPM, the air is also gradually decreased to a flow rate of 0.5 LPM and the supply of the nitrogen gas is completely stopped. When the output voltage is at a steady state, the performance test of the vapor/carbon dioxide co-electrolysis stacks is started.

An example of switch from the performance test of the vapor/carbon dioxide co-electrolysis stacks to the performance test of the fuel cell stacks is described as follows. When the performance test of the vapor/carbon dioxide co-electrolysis stacks is selected, hydrogen gas at a flow rate of 0.22 LPM and a steam generated by pure water at a flow rate of 0.64 ml/min are conducted into the first gas path 13, and air at a flow rate of 0.5 LPM is conducted into the second gas path 14. Afterwards, when the process is switched to the performance test of the fuel cell stacks, the supply of the pure water is stopped, and the hydrogen gas is gradually increased to a flow rate of 0.8 LPM. At the same time, nitrogen gas is conducted into the first gas path 13 at a flow rate of 0.2 LPM, and air is increased to a flow rate of 2 LPM. When output voltage measured in the power load device 90 is at a steady state, the performance test of the fuel cell stacks is started.

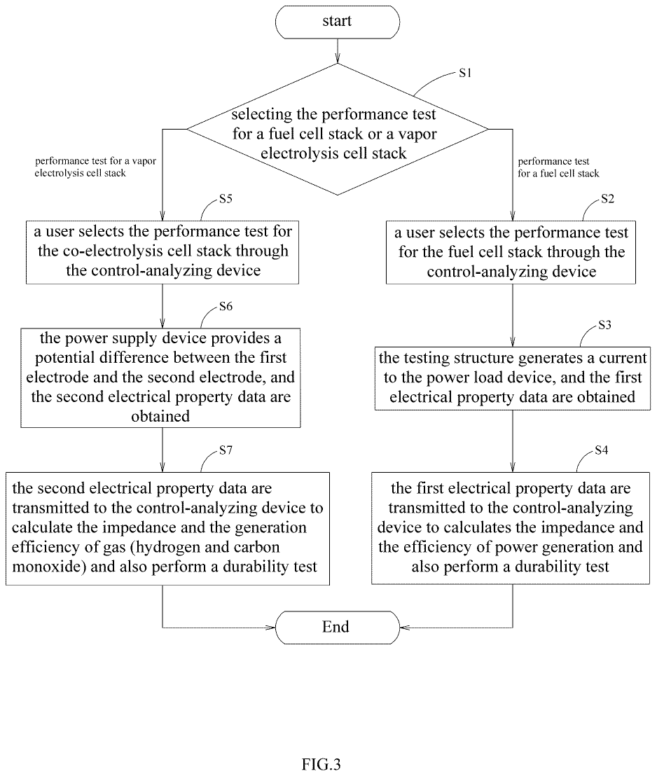

Referring to FIG. 3, a process of the selection of the performance test operated by the testing system of selective dual mode type for fuel cell stacks or vapor/carbon dioxide co-electrolysis stacks. In the step S1, the performance test is selected for the fuel cell stack or the electrolysis stack. If the performance test is selected for the fuel cell stack, then the process enters the step S2. If the performance test is selected for the electrolysis stack, then the process enters the step S5.

In the step S2, a user selects the performance test for the fuel cell stack through the control-analyzing device 100. The control-analyzing device 100 starts the reactant gas preheating device 30 and provides the temperature settings. The control-analyzing device 100 also starts the vapor supply device 40 and allows the vapor to enter the reactant gas preheating device 30 and mix with the reactant gas. The control-analyzing device 100 switches the switching valve 70 to enable the communication of the reactant gas supply device 20 and the testing structure 10, whereby the reactant gas enters the testing structure 10 to start the fuel cell reaction. Afterwards, the process enters the step S3.

In the step S3, the testing structure 10 generates a current to the power load device 90, and the first electrical property data are obtained at the power load device 90. Afterwards, the process enters the step S4.

In the step S4, the first electrical property data are transmitted to the control-analyzing device 100, which calculates the impedance and the efficiency of power generation and also performs a durability test.

In the step S5, the user selects the performance test for the electrolysis stack through the control-analyzing device 100. The control-analyzing device 100 starts the vapor supply device 40 and switches the switching valve 70 to enable the communication of the vapor supply device 40 and the testing structure 10, whereby the vapor enters the testing structure 10. The power supply device 80 is also started. Afterwards, the process enters the step S6.

In the step S6, the power supply device 80 provides a potential difference between the first electrode 11 and the second electrode 12 for the electrolysis reaction, and the second electrical property data are obtained at the power supply device 80. Afterwards, the process enters the step S7.

In the step S7, the second electrical property data are transmitted to the control-analyzing device 100, which calculates the impedance and the efficiency of gas (hydrogen) generation also performs a durability test.

The testing system of selective dual mode type for fuel cell stacks or vapor/carbon dioxide co-electrolysis stacks utilizes a single test structure to selectively operate the performance tests for fuel cell stacks or electrolysis stacks without changing the stacks as the prior art does, whereby the failure condition of the stack is prevented. Moreover, the first electrical property data and the second electrical property data are obtained from the power load device and the power supply device disposed outsides the test structure, and the first electrode and the second electrode of the test structure are connected to the power load device and the power supply device through multiple transmitting wires, whereby the failure condition caused by overload of the single transmitting wire is avoided.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A testing system of selective dual mode type for fuel cell stacks or vapor/carbon dioxide co-electrolysis stacks, comprising:
at least one testing structure comprising a first electrode, a second electrode, a first gas path adjacent to the first electrode, a second gas path adjacent to the second electrode, and an ion conducting layer disposed between the first gas path and the second gas path;
a reactant gas supply device providing a plurality of reactant gases selectively entering the first gas path and the second gas path;
a vapor supply device providing an vapor selectively entering the first gas path or the second gas path;
a power supply device connected to the first electrode and the second electrode;
a power load device connected to the first electrode and the second electrode; and
a control-analyzing device electrically connected to the power supply device and the power load device;
wherein when the at least one testing structure is operated as a fuel cell stack, the reactant gases enter the first gas path and the second gas path, and a current is generated between the first electrode and the second electrode and flows through the power load device, whereby the control-analyzing device obtains a plurality of first electrical property data of the power load device;
wherein when the at least one testing structure is operated as a vapor/CO₂ co-electrolysis stack, the power supply device provides a potential difference between the first electrode and the second electrode, the vapor enters the first gas path, whereby a plurality of electrolysis gases are generated at the first electrode and the second electrode and discharged from the testing structure, and the control-analyzing device obtains a plurality of second electrical property data of the power load device.

2. The testing system of selective dual mode type for fuel cell stacks or vapor/carbon dioxide co-electrolysis stacks as claimed in claim 1, further comprising a reactant gas preheating device connected to the reactant gas supply device and the testing structure, wherein the reactant gases enter the reactant gas pre-heating device from the reactant gas supply device and is heated therein to a predetermined temperature, the heated reactant gases enter the testing structure.

3. The testing system of selective dual mode type for fuel cell stacks or vapor/carbon dioxide co-electrolysis stacks as claimed in claim 2, further comprising a furnace housing the test structure, wherein the furnace is operated at a high temperature, and the reactant gas preheating device is disposed outsides the furnace.

4. The testing system of selective dual mode type for fuel cell stacks or vapor/carbon dioxide co-electrolysis stacks as claimed in claim 2, wherein the reactant gas pre-heating device is electrically connected to the control-analyzing device where a value of the predetermined temperature is set.

5. The testing system of selective dual mode type for fuel cell stacks or vapor/carbon dioxide co-electrolysis stacks as claimed in claim 2, wherein the reactant gas supply device comprises a reactant gas storage tank and a reactant gas pump, and the reactant gases enter the reactant gas pre-heating device from the reactant gas storage tank or after the reactant gases are pressurized by the reactant gas pump.

6. The testing system of selective dual mode type for fuel cell stacks or vapor/carbon dioxide co-electrolysis stacks as claimed in claim 1, further comprising a furnace housing the test structure, wherein the furnace is operated at a high temperature.

7. The testing system of selective dual mode type for fuel cell stacks or vapor/carbon dioxide co-electrolysis stacks as claimed in claim 1, further comprising a storage tank and a pump, wherein water is stored in the storage tank, water enters the pump from the storage tank and is pressurized therein, and the pressurized water enters the vapor supply device.

8. The testing system of selective dual mode type for fuel cell stacks or vapor/carbon dioxide co-electrolysis stacks as claimed in claim 7, wherein the vapor supply device is electrically connected to the control-analyzing device, whereby the control-analyzing device controls a heating power for the vapor supply device.

9. The testing system of selective dual mode type for fuel cell stacks or vapor/carbon dioxide co-electrolysis stacks as claimed in claim 1, further comprising a switching valve connected to the reactant gas supply device, the vapor supply device and the testing structure, wherein the switching valve is operated to switch communication of the reactant gas supply device with the testing structure or the vapor supply device with the testing structure.

10. The testing system of selective dual mode type for fuel cell stacks or vapor/carbon dioxide co-electrolysis stacks as claimed in claim 9, wherein the switching valve is connected to and controlled by the control-analyzing device.

11. The testing system of selective dual mode type for fuel cell stacks or vapor/carbon dioxide co-electrolysis stacks as claimed in claim 10, wherein the reactant gas supply device and the vapor supply device are electrically connected to the control-analyzing device.

12. The testing system of selective dual mode type for fuel cell stacks or vapor/carbon dioxide co-electrolysis stacks as claimed in claim 1, wherein the control-analyzing device controls a switch between a performance test of fuel cell stacks and a performance test of vapor/carbon dioxide co-electrolysis stacks.

13. The testing system of selective dual mode type for fuel cell stacks or vapor/carbon dioxide co-electrolysis stacks as claimed in claim 1, further comprising an gas collection device, wherein the electrolysis gases discharged from the testing structure enter the gas collection device for storage.

14. The testing system of selective dual mode type for fuel cell stacks or vapor/carbon dioxide co-electrolysis stacks as claimed in claim 1, wherein the reactant gases comprise hydrogen, carbon monoxide, carbon dioxide and oxygen, and steam.
